(19) United States
(12) Patent Application Publication
(10) Pub. No.: US 2011/0064893 A1
(43) Pub. Date: Mar. 17, 2011

(54) INK-JET RECORDING MEDIUM

(76) Inventors: Taichi Watanabe, Tokyo (JP); Yuji Sawa, Tokyo (JP)

(21) Appl. No.: 12/921,078

(22) PCT Filed: Mar. 4, 2009
(86) PCT No.: PCT/JP2009/054032

§ 371 Date: Nov. 30, 2010

(30) Foreign Application Priority Data
Mar. 5, 2008 (JP) 2008-055330

(51) Int. Cl. B41M 5/50

(52) U.S. Cl. 428/32.21

(57) ABSTRACT

An inkjet recording medium comprising an ink-receiving layer containing kaolin, synthetic amorphous silica and a binder formed on one surface or both surfaces of a base paper mainly containing a wood pulp, wherein the kaolin has a particle size distribution in which a percentage of particles having a size of from 0.4 μm or more to less than 4.2 μm which account for 60% or more of the total as the cumulative value of the volumetric basis by a laser diffraction particle size distribution measurement, and the synthetic amorphous silica has a mean secondary particle diameter of from 0.5 μm or more to 4 μm or less measured by a coulter counter method.

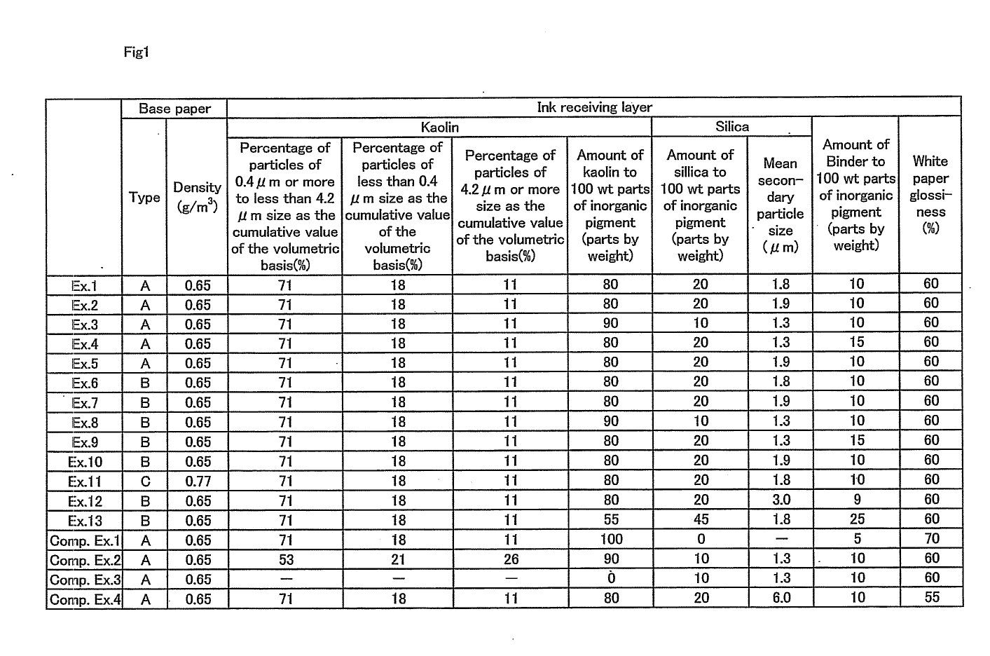

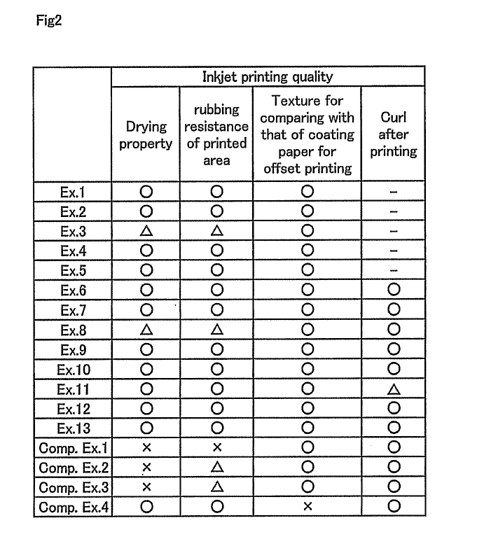

### FIELD OF THE INVENTION

The present invention relates to an inkjet recording medium having a texture similar to that of a coating paper for offset printing.

### DESCRIPTION OF THE RELATED ART

An inkjet recording method can readily provide full color prints and less noise upon printing, and has been used for many applications along with the rapid improvement in printing performance. These applications involves, for example, a document recording from a word-processing software, a digital image recording such as a digital photograph, a copy of a beautiful print such as a silver halide photograph and a book loaded using a scanner, and an exhibition imaging preparation such as a relatively small number of posters.

There is proposed an inkjet recording medium suitable for each application. For example, when simple characters are recorded, a plain paper type medium for directly recording on a paper is used. In the case that it is needed to provide resolution and color reproducibility comparable to those of the silver halide photograph, there is used a coating paper type having an ink receiving layer as a coating layer. In the case that especially high gloss is needed, there is used a cast-coated paper type having a coating layer for a coating paper type formed by a cast coating. In the case of posters or exhibition applications, there is developed and used a roll type having a coating layer.

One of the fields to which the inkjet recording method is applied is the printing field. Conventionally, in this field, an offset printing has mainly been used. The offset printing requires a form plate, and involves plate making and printing steps. It takes a certain amount of time for providing a printed matter. On the other hand, in the inkjet printing, it is very effective in that an image is directly formed on a recording medium to provide a printed matter. The printed matter can be produced at a low cost. Meanwhile, as an alternative of the conventional printed matter, the printed matter should have a texture similar to that provided by the offset printing.

When a high quality inkjet recording image is printed, an amount of ink discharged from a printer is increased so as to improve the color reproducibility in the image. Therefore, an ink receiving layer which has a sufficient ink absorption performance (speed and capacity) is required. Because of this, a porous material such as synthetic amorphous silica is often used as the ink receiving layer of the inkjet recording medium. In this case, although the ink absorption performance is improved, gloss is poor and the texture is undesirably different from that of the offset printed matter. When the inkjet recording medium is a cast-coated paper including the ink receiving layer having high gloss, it has very high gloss as compared with that of the common coating paper for offset printing, is thick, and thus has also different texture from that of the offset printed matter. In addition, since a great amount of an expensive material such as silica, alumina, polyvinyl alcohol, an ethylene vinyl acetate emulsion, an ink fixing agent (polyamine based, DADMAC based, polyamidine based and the like) is used in the inkjet recording medium, the manufacturing cost of the inkjet recording medium is higher than the common coating paper for offset printing.

When a common coating paper for offset printing containing kaolin or calcium carbonate as a pigment of the coating layer is printed using an inkjet printer, a phenomenon such as feathering (blurring), bleed (blurred outlines), uneven printing of solid image (uneven image density), cockling (undulation of printed areas) and rubbing (scratch of the printing) is induced due to low ink absorption capacity in the coating layer.

In order to solve these problems, consideration is given from both aspects of ink and paper. For example, Patent Literature 1 suggests an inkjet aqueous pigment ink for printing on an inkjet recording paper comprising not less than 90 parts by weight of kaolin as a pigment for forming an ink receiving layer, wherein 5 to 15 parts by weight of the kaolin has a mean particle size of not less than 1.5 μm, and wherein a ratio of the pigment to a hydrophilic polymer compound is 60/40 to 95/5.

Patent Literature 2 discloses an inkjet recording medium having a texture similar to that of a common coating paper comprising a bottom ink receiving layer mainly containing kaolin and amorphous synthetic silica on a surface of a support, and a upper ink receiving layer containing fumed alumina as a main pigment.

Patent Literature 3 discloses an inkjet recording sheet, which is suitable not only for a pigment ink but also for a dye ink, comprising 10 to 90% by weight of silica and 90 to 10% by weight of calcium carbonate and/or kaolinite in an ink receiving layer.

Patent Literature 4 discloses an inkjet recording paper comprising a pigment having a mean particle size of 0.2 to 2.0 μm and satisfying 1≦L/W≦50 (L represents a longer diameter and W represents a shorter diameter (thickness) of a particle) in a recording layer (ink receiving layer), and having gloss at 75 degree according to JIS-Z8741 of not less than 40%.

### [Patent Literature 1] Unexamined Japanese Patent Publication (Kokai) 2004-91627

### [Patent Literature 2] Unexamined Japanese Patent Publication (Kokai) 2005-103827

### [Patent Literature 3] Unexamined Japanese Patent Publication (Kokai) 2005-297473

### [Patent Literature 4] Unexamined Japanese Patent Publication (Kokai) 2004-209965

### Problems to be Solved by the Invention

As described above, an attempt to conduct inkjet recording on a common coating paper for offset printing or an inkjet recording paper having a similar texture has been made. However, sufficient printing quality has not been provided yet.

When the pigment ink disclosed in Patent Literature 1 is used for printing on a recording paper having low white paper glossiness (matte inkjet recording paper), rubbing resistance can be provided on the printed area to some degree, but is insufficient. Especially when the pigment ink is printed on a recording paper having high white paper glossiness (glossy inkjet recording paper), the required rubbing resistance cannot be provided. In the inkjet recording medium described in Patent Literature 2, two ink receiving layers are required, resulting in high costs. In the inkjet recording sheet described in Patent Literature 3, silica and calcium carbonate or kaolin are used together, and it is therefore difficult to provide the ink absorption performance and glossiness approaching the coating paper for offset printing at the same time. Also, the inkjet recording paper as described in Patent Literature 4 has glossiness, but insufficient ink absorption performance and rubbing resistance on the printed area.

Therefore, the object of the present invention is to provide an inkjet recording medium having a texture similar to that of the coating paper for offset printing, excellent rubbing resistance and printing quality on the printed area when a pigment ink is used for inkjet recording by decreasing costs.

### SUMMARY OF THE INVENTION

Through diligent studies about the inkjet recording medium suitable for inkjet printing that provides a texture similar to that of the coating paper for offset printing, the present inventors found that the above-described problem can be solved by specifying a type of a pigment in the ink receiving layer.

The present invention provides an inkjet recording medium comprising an ink-receiving layer containing kaolin, synthetic amorphous silica and a binder formed on one surface or both surfaces of a base paper mainly containing a wood pulp, wherein the kaolin has a particle size distribution in which a percentage of particles having a size of from 0.4 μm or more to less than 4.2 μm which account for 60% or more of the total as the cumulative value of the volumetric basis by a laser diffraction particle size distribution measurement, and the synthetic amorphous silica has a mean secondary particle diameter of from 0.5 μm or more to 4 μm or less measured by a coulter counter method.

Preferably, the synthetic amorphous silica is gel type silica. Preferably, the ink-receiving layer contains an organic pigment as a pigment. And preferably, a high-bulk paper is used as the base paper.

According to the present invention, there is provided an inkjet recording medium having a texture similar to that of the coating paper for offset printing, excellent rubbing resistance and printing quality on the printed area when a pigment ink is used for inkjet recording with low costs.

### DESCRIPTION OF THE PREFERRED EMBODIMENTS

Embodiments of the inkjet recording medium according to the present invention are explained below.

### (Base Paper)

Base paper mainly comprises wood pulp. As raw material pulp, chemical pulp (for example, bleached or unbleached softwood kraft pulp, bleached or unbleached hardwood kraft pulp), mechanical pulp (for example, ground pulp, thermomechanical pulp and chemithermomechanical pulp), and de-inked pulp can be used alone or in combination in any ratio.

The pH of the base paper may be acidic, neutral and alkaline. When the amount of the loading filler in base paper is increased, opacity of the paper tends to be improved. Therefore, the paper preferably contains the loading filler. As the loading filler, known loading filler including hydrated silica, white carbon, talc, kaolin, clay, calcium carbonate, titanium oxide, synthetic resin fillers and the like can be used. The base paper according to the present invention may contain an auxiliary agent such as aluminum sulfate, a sizing agent, a paper strengthening additive, a yield improving agent, a coloring agent, a dye, an antifoaming agent, a pH adjusting agent and the like, if desired. The base paper may have any basis weight, which is not especially limited.

According to the present invention, preferably a high-bulk paper is used as the base paper. The high-bulk paper has a lower density (about 0.5 to 0.7 g/m³) than a plain paper, and can be provided by making a paper using known methods, i.e., blending a chemical for lowering the density into a pulp slurry, blending a high-bulk loading filler and the like. Examples of the chemical for lowering the density include an oil-based nonionic surfactant, a sugar alcohol-based nonionic surfactant, a sugar-based nonionic surfactant, a multivalent alcohol-based nonionic surfactant such as a fatty acid ester of a multivalent alcohol, a higher alcohol, an ethylene oxide or propylene oxide adduct of a higher alcohol or a higher fatty acid, fatty acid polyamide amine, saturated fatty acid monoamide, an aliphatic quaternary ammonium salt and the like. Especially preferred is saturated fatty acid monoamide. Such a paper includes a neutral high-bulk paper described in Unexamined Japanese Patent Publication (Kokai) 2005-54331. As the high-bulk loading filler, amorphous silicate disclosed in Unexamined Japanese Patent Publication (Kokai) 2001-214395 and inorganic time particle-silica composite aggregate particles disclosed in Unexamined Japanese Patent Publication (Kokai) 2003-49389 can be used. When the high-bulk paper is used as the base paper, there are advantages that the paper has high stiffness to show excellent feeding ability, and is dimensionally stable so as to decrease curl and cockling, as compared with the plain paper having the same basis weight.

Before the ink-receiving layer is disposed on the base paper according to the present invention, the base paper may be impregnated in or coated with a size press liquid prepared from starch, polyvinyl alcohol, and a sizing agent in order to strengthen the paper and adding sizing properties. A way to impregnate or coat is not especially limited. Preferably, an impregnation method such as a pond size press, or a coating method such as a rod metering size press, a gate roll coater and a blade coater is used. When the size press liquid is impregnated or coated, an auxiliary agent such as a fluorescent dye, a conductive agent, a water retention agent, a water resistant additive, a pH adjusting agent, an antifoaming agent, a lubricant, a preservative, a surfactant and the like can be mixed in any percentage, as needed, within the ranges that do not adversely affect on the effect of the present invention.

### (Ink Receiving Layer)

### 1. Pigment in the Ink Receiving Layer

The pigment in the ink receiving layer mainly comprises kaolin having a particle size distribution in which a percentage of particles having a size of from 0.4 μm or more to less than 4.2 μm which account for 60% or more of the total as the cumulative value of the volumetric basis by a laser diffraction particle size distribution measurement. Kaolin is a clay containing at least one kaolin mineral such as kaolinite, halloysite, dickite and nacklite. Any known kaolin for use in the common coating paper for offset printing may be used. Kaolin is produced in Georgia, Brazil, China and the like, may have any grade such as primary, secondary, and delaminated grades, and can be used alone or in combination as appropriate. A sample slurry is dropped into and mixed with pure water to form a uniform dispersion, which is measured for the particle size distribution using a laser particle size measuring system (device used: Mastersizer type S manufactured by Malvern Instruments Ltd).

The kaolin having above-defined particle size distribution has a sharp particle size distribution as compared with common kaolin, has a uniform particle size, and forms a porous and bulk ink receiving layer having pigment particles with a low loading density. The porous ink receiving layer has a greater mean void size than that of the ink receiving layer having pigment particles with a high loading density, and has therefore excellent ink absorption performance. This advantageous effect can be provided by kaolin having the sharper particle size distribution. The particle size distribution has preferably a percentage of particles having a size of from 0.4 μm or more to less than 4.2 μm which account for 65% or more of the total as the cumulative value of the volumetric basis by the laser diffraction particle size distribution measurement. In place of kaolin having the above-defined particle size distribution, kaolin having a particle size distribution having a percentage of particles having a size of from 0.4 μm or more to less than 4.2 μm which account for less than 60% of the total as the cumulative value of the volumetric basis by the laser diffraction particle size distribution measurement, and including many particles each having a particle size of less than 0.4 μm is used, the ink receiving layer becomes densified, which leads to poor ink absorption performance. Also, kaolin having a particle size distribution having a percentage of particles having a size of from 0.4 μm or more to less than 4.2 μm which account for less than 60% of the total as the cumulative value of the volumetric basis by the laser diffraction particle size distribution measurement, and including many particles each having a particle size of greater than 4.2 μm is used, the ink receiving layer becomes densified and the pigment particles on the ink receiving layer have less spaces, which lead to poor ink absorption performance.

The ink receiving layer contains synthetic amorphous silica as an essential component other than kaolin. The synthetic amorphous silica has a mean secondary particle diameter of from 0.5 μm or more to 4 μm or less. When the mean secondary particle size exceeds 4 μm, the resultant inkjet recording medium may have different smoothness and glossiness from those of the coating paper for offset printing. Also, the ink is excessively permeated to undesirably lower the color development and induce unevenness. When the mean secondary particle size is less than 0.5 μm, the ink absorption performance may be lowered, and the viscosity of the coating material may be increased when dispersing the pigment to lower the dispersibility of the coating material. The mean secondary particle size of the synthetic amorphous silica is preferably from 0.6 μm or more to 3 μm or less. The mean secondary particle size of the synthetic amorphous silica can be measured by a coulter counter method.

Oil absorption of the synthetic amorphous silica for use in the present invention is not especially limited, but is preferably from 150 ml/100 g or more to 500 ml/100 g or less. When the oil absorption is less than 150 ml/100 g, ink retention capacity in the ink receiving layer is not sufficient, and the rubbing resistance on the printed area and the ink absorption performance may be poor. When the oil absorption exceeds 500 ml/100 g, the viscosity of the coating material may be increased to decrease the dispersibility of the coating material, when the pigment is dispersed. The oil absorption of the synthetic amorphous silica is more preferably from 200 ml/100 g or more to 400 ml/100 g or less. The oil absorption is measured by the method in accordance with JIS K5101.

The synthetic silica of the present invention is preferably gel type silica. The gel type silica refers to wet synthetic amorphous silica particles, which is produced by a neutralization reaction between sodium silicate and a mineral acid (typically, sulfuric acid) at acidic pH to aggregate the particles while the growth of primary particles is suppressed. The gel type silica tends to have a longer reaction time after aggregation, a stronger bond between the primary particles, and a greater pore volume as compared with precipitated type silica (produced by a neutralization reaction between sodium silicate and a mineral acid at alkali pH). Thus, the gel type silica is preferably used in that the ink absorption performance and the rubbing resistance are excellent.

According to the present invention, a ratio of the above-described kaolin and the synthetic amorphous silica (kaolin/synthetic amorphous silica) is preferably 95/5 to 50/50. When the percentage of the silica is low, the ink absorption performance and the rubbing resistance to be intended is difficult to be provided. When the percentage of the silica is high, cracks may be produced on the surface of the ink receiving layer, the ink may be excessively permeated, the color development may be poor, and the unevenness may be induced. In addition, as the percentage of the silica is increased, the texture of the offset printing paper is hardly obtained, and the glossiness is difficult to be obtained so as to provide a glossy recording paper.

Any known inorganic pigments for use in the common coating paper for offset printing other than kaolin and synthetic amorphous silica may be used for the ink receiving layer. As the inorganic pigment, other kaolin than used in the present invention, other silica than used in the present invention, ground calcium carbonate, precipitated calcium carbonate, silica composite calcium carbonate, talc, calcined kaolin obtained by calcination of the above-mentioned kaolin, calcium sulfate, barium sulfate, titanium dioxide, zinc oxide, alumina, magnesium carbonate, magnesium oxide, calcium silicate, bentonite, zeolite, sericite and smectite can be used alone or in combination. The inorganic pigment is preferably added in amount of 10% by weight or less based on the total amount of the kaolin and the synthetic amorphous silica.

According to the present invention, the ink receiving layer preferably contains an organic pigment such as a plastic pigment as appropriate, in order to improve white paper glossiness of the surface of the ink receiving layer. The organic pigment is preferably added in amount of 0 to 40 parts by weight, more preferably 0 to 30 parts by weight, still more preferably 1 to 25 parts by weight, based on 100 parts by weight of the inorganic pigment (the total amount or the inorganic pigment in the ink receiving layer including the kaolin and the synthetic amorphous silica). When no organic pigment is added at all, the matte inkjet recording medium of the present invention can be produced without a problem, but the glossy inkjet paper may be produced with insufficient glossiness. In particular, the glossiness of the ink receiving layer is decreased in inversely proportion to the amount of the synthetic amorphous silica used in the present invention. Therefore, the glossy inkjet paper is produced by increasing the amount of the organic pigment in proportion to the amount of the synthetic amorphous silica. When the amount of the organic pigment exceeds 40 parts by weight, the organic pigment is fused and adhere to the metal roll through the calender heated at high temperature, which leads to tearing or breaking of the paper. The amount of the organic pigment for producing the matte inkjet paper is not especially limited.

The organic pigment for use in the present invention can be a solid, hollow or core-shell type, and can be used alone or in combination, where appropriate. The organic pigment is composed of a polymer mainly comprising a monomer such as styrene and/or methyl methacrylate, and other monomer that can be copolymerized with the monomer, as needed. Examples of the copolymerizable monomer include an olefinic aromatic monomer such as α-methylstyrene, chlorostyrene and dimethylstyrene, a mono olefinic monomer such as methyl (meth)acrylate, ethyl (meth)acrylate, butyl (meth)acrylate, 2-ethylhexyl (meth)acrylate, glycidyl (meth)acrylate and nitrile (meth)acrylate, and vinyl acetate. If desired, olefinic unsaturated carboxylic acid monomers such as acrylic acid, methacrylic acid, itaconic acid, maleic acid, fumaric acid and crotonic acid; olefinic unsaturated hydroxy monomers such as hydroxyethyl, hydroxyethyl methacrylate, hydroxypropyl acrylate and hydroxypropyl methacrylate; olefinic unsaturated amide monomers such as acrylamide, methacrylamide, N-methylol acrylamide, N-methylol methacrylamide and N-methoxymethyl acrylamide; and dimer vinyl monomers such as divinylbenzene can be used alone or in combination. These monomers are illustrative and other copolymerizable monomers, if any, can be used.

### 2. Binder in the Ink Receiving Layer

As the binder for use in the ink-receiving layer, any known binder used in the common coating paper for offset printing may be used. For example, as the binder, starches such as oxidized starch, etherified starch and esterified starch; latexes such as styrene butadiene copolymer (SB) latex and acrylonitrile butadiene copolymer (NB) latex; polyvinyl alcohol and its derivatives; casein, gelatin, carboxy methyl cellulose, polyurethane, vinyl acetate and unsaturated polyester resin can be used alone or in combination. From the standpoints of fluidity and coating adequacy of the coating prepared, it is preferable that latexes, starches, or their combination are used.

The binder is preferably added in amount of from 4 parts or more to not greater than 35 parts by weight based on 100 parts by weight of the total inorganic pigment in the ink-receiving layer. If the binder is added in amount of less than 4 parts by weight, the ink receiving layer tends to have insufficient strength. If the binder is added in amount greater than 35 parts by weight, the void in the ink receiving layer is filled with the binder to lower the absorptive capacity, whereby it may be difficult to provide the excellent printing quality. More preferably, the binder is added in amount of from 5 parts or more to less than 30 parts by weight based on 100 parts by weight of the inorganic pigment.

### (Other Components)

To the ink receiving layer, an auxiliary agent such as a pigment dispersing agent, a thickener, a water retention agent, a lubricant, an antifoaming agent, a mold release agent, a foaming agent, a coloring dye, a coloring pigment, a fluorescent dye, an antiseptic agent, a water resistant additive, a surfactant, and a pH adjusting agent can be added, as required.

### (Coating Weight)

The coating weight of the ink receiving layer is not especially limited, but is preferably from 1 g/m² or more to less than 40 g/m², and more preferably from 4 g/m² or more to less than 30 g/m² on one surface. The greater the coating weight is, the greater the void in the ink receiving layer is. Thus, the ink receiving layer has good ink absorption performance. When the coating weight of the ink receiving layer is less than 1 g/m² on one surface, the base paper cannot be fully coated. The coating paper may have a rough surface and a texture similar to that of a non-coating paper. As a result, it is difficult to provide desired white paper glossiness to be intended by the present invention, and the intended inkjet recording medium having a texture of a coating paper for offset printing cannot be obtained. And when the coating weight is less than 1 g/m² on one surface, the ink receiving layer has not sufficient absorptive capacity, which may lead to printing defects such as feathering and bleeding. When the coating weight of the ink receiving layer exceeds 40 g/m² on one surface, the dry load upon coating is high, which may decrease the workability and increase the costs.

### (Coating Method)

When the ink receiving layer is formed on the base paper, commonly used applicators such as blade coaters, roll coaters, air knife coaters, bar coaters, gate roll coaters, curtain coaters, gravure coaters, flexographic gravure coaters, spray coaters, size presses and the like can be used on-machine or off-machine. One or more ink receiving layer may be formed on one or both surfaces of the base paper. According to the present invention, sufficient performance can be provided even with one ink receiving layer. It is preferable that only one layer is formed from the viewpoint of reducing the costs.

### (White Paper Glossiness)

White paper glossiness of the surface of the ink receiving layer in the inkjet recording medium measured at a light incident angle of 75 degree according to JIS-Z8741 is not especially limited, and can be set depending on the applications, as required. For example, in order to provide the paper obtained by the present invention with the texture of the glossy coating paper for offset printing, the white paper glossiness is preferably from 55% or more to 85% or less. In addition, in order to provide it with the texture of the matte coating paper for offset printing, the white paper glossiness is preferably from 20% or more to less than 55%.

The white paper glossiness can be obtained by adjusting and selecting the conditions including a processing temperature, a processing speed, a processing linear pressure, a processing stage number, a roll diameter and a material, as required, and surface-treating using a calender device such as a machine calender, a super calender, a soft calender, and a shoe calender. Only when the matte coating paper for offset printing is produced, the white paper glossiness may be obtained without no calendering.

### Examples

The present invention is explained in further detail by presenting specific examples below, but the present invention is not limited by these examples. The terms “parts” and “%” refer to “parts by weight” and “% by weight” described herein, respectively, unless otherwise rioted.

A sample slurry containing kaolin was mixed dropwise with pure water to a uniform dispersion. The particle size distribution of kaolin was measured using a laser particle size measuring system (device used: Mastersizer type S manufactured by Malvern Instruments Ltd). Thus, the measured value for the particle size distribution of kaolin was used.

The mean secondary particle size of the synthetic amorphous was measured by a coulter counter method (device used: Multisizer 3 manufactured by Beckman Coulter Inc.).

### (Preparation of a Chemical a for Lowering the Density)

Stearic acid amide, potassium cocoate as an emulsifier and hot water at 95° C. were placed into a high pressure homogenizer at a weight ratio of stearic acid amide/potassium cocoate/hot water=5/0.5/94.5, processed under pressure of 54 MPa for 10 minutes, and diluted and cooled with freshwater to provide an emulsion-type chemical A for lowing the density.

### (Preparation of Base Paper a)

70% by weight of bleached hard wood kraft pulp (480 ml freeness) and 30% by weight of bleached soft wood kraft pulp (500 ml freeness) were mixed. 0.5% of cationic starch based on the pulp, 0.05% of alkyl ketene dimer based on the pulp, 2% of aluminum sulfate based on the pulp, and 10% of calcium carbonate based on the pulp were added to the pulp. And as the chemical for lowering the density, 0.3 parts of an ester compound of polyhydric alcohol and fatty acid (KB-110 manufactured by KAO Corporation) was added to provide a stock. The stock was formed into a web using a Fourdrinier paper machine. The web was pressed through three sets of press rolles, dried, coated with 10% by weight of a starch oxide solution using a gate roll coater, and dried again. Thus, there was provided a base paper having a basis weight of 80 g/m² and a density of 0.65 g/cm³.

### (Preparation of Base Paper B)

To 100% by weight of bleached hard wood kraft pulp (400 ml freeness), 0.5% of cationic starch based on the pulp, 0.05% of alkyl ketene dimer based on the pulp, 2% of aluminum sulfate based on the pulp, and 10% of calcium carbonate based on the pulp were added. And 0.3 parts of the chemical A for lowering the density was added to provide a stock. The Stock was formed into a web using a Fourdrinier paper machine. The web was pressed through three sets of press rolles, dried by cylinder dryer, coated with 10% by weight of a starch oxide solution using a gate roll coater, dried again, and processed by a machine calender. Thus, there was provided a base paper having a basis weight of 80 g/m² and a density of 0.65 g/cm³.

### (Preparation of Base Paper C)

To 100% by weight of bleached hard wood kraft pulp (400 ml freeness), 0.5% of cationic starch based on the pulp, 0.05% of alkyl ketene dimer based on the pulp, 2% of aluminum sulfate based on the pulp, and 15% of calcium carbonate based on the pulp were added to provide a stock. The stock was formed into a web using a Fourdrinier paper machine. The web was wet pressed, dried by cylinder dryer, coated with 10% by weight of a starch oxide solution using a gate roll coater, dried again, and processed by a machine calender. Thus, there was provided a base paper having a basis weight of 80 g/m² and a density of 0.77 g/cm³.

### Example 1

80 parts of the kaolin A (product name: Capim DG, manufactured by Imerys Ltd.) a percentage of particles having a size of from 0.4 μm or more to less than 4.2 μm as the cumulative value of the volumetric basis: 71%), 20 parts of the a synthetic morphous silica A (product name: NIPGEL AY-200, manufactured by Tosoh Silica Corporation having a mean secondary particle diameter of 1.8 μm), 20 parts of the organic pigment A (a modified styrene based copolymer, product name: L8900, manufactured by Asahi Kasei Chemicals Corporation), 10 parts of styrene butadiene copolymer (SB) latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper A, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 2

80 parts of the kaolin A, 20 parts of the synthetic amorphous silica B (product name: NIPGEL AZ-200, manufactured by Tosoh Silica Corporation having a mean secondary particle diameter of 1.9 μm), 20 parts of the organic pigment A, 10 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper A, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 3

80 parts of the kaolin A, 10 parts of the synthetic amorphous silica C (product name: NIPGEL AZ-204, manufactured by Tosoh Silica Corporation having a mean secondary particle diameter of 1.3 μm), 10 parts of the organic pigment A, 10 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper A, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 4

80 parts of the kaolin A, 20 parts of the synthetic amorphous silica C, 20 parts of the organic pigment A, 15 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper A, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 5

80 parts of the kaolin A, 20 parts of the synthetic amorphous silica D (product name: NIPGEL AZ-260, manufactured by Tosoh Silica Corporation having a mean secondary particle diameter of 1.9 μm), 20 parts of the organic pigment A, 10 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper A, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 6

80 parts of the kaolin A (product name: Capim DG, manufactured by Imerys Ltd., a percentage of particles having a size of from 0.4 μm or more to less than 4.2 μm as the cumulative value of the volumetric basis: 71%), 20 parts of the synthetic amorphous silica A (product name: NIPGEL AY-200, manufactured by Tosoh Silica Corporation having a mean secondary particle diameter of 1.8 μm), 20 parts of the organic pigment A (a modified styrene based copolymer, product name: L8900, manufactured by Asahi Kasei Chemicals Corporation), 10 parts of styrene butadiene copolymer (SB) latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper B, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 7

80 parts of the kaolin A, 20 parts of the synthetic amorphous silica B (product name: NIPGEL AZ-200, manufactured by Tosoh Silica Corporation having a mean secondary particle diameter of 1.9 μm), 20 parts of the organic pigment A, 10 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper B, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 8

80 parts of the kaolin A, 10 parts of the synthetic amorphous silica C (product name: NIPGEL AZ-204, manufactured by Tosoh Silica Corporation having a mean secondary particle diameter of 1.3 μm), 10 parts of the organic pigment A, 10 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper B, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 9

80 parts of the kaolin A, 20 parts of the synthetic amorphous silica C, 20 parts of the organic pigment A, 15 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper B, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 10

80 parts of the kaolin A, 20 parts of the synthetic amorphous silica D (product name: NIPGEL AZ-260, manufactured by Tosoh Silica Corporation having a mean secondary particle diameter of 1.9 μm), 20 parts of the organic pigment A, 10 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper B, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 11

80 parts of the kaolin A, 20 parts of the synthetic amorphous silica A, 20 parts of the organic pigment A, 10 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper C, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 12

80 parts of the kaolin A, 20 parts of the synthetic amorphous silica B (product name: NIPGEL AZ-400, manufactured by Tosoh Silica Corporation having a mean secondary particle diameter of 3.0 μm), 20 parts of the organic pigment A, 9 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper B, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Example 13

55 parts of the kaolin A, 45 parts of the synthetic amorphous silica C, 30 parts of the organic pigment A, 25 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper B, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Comparative Example 1

100 parts of the kaolin A, 5 parts of SB latex (glass transition temperature of 15° C.) as the binder, 0.1 parts of sodium hydroxide, 0.2 parts of sodium polyacrylate as the dispersant, and dilution water were mixed to provide a coating material having 65% solid content. On both surfaces of the base paper A, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 70% to provide an inkjet recording medium.

### Comparative Example 2

90 parts of Kaolin B (product name: KCS, manufactured by Imerys Ltd., a percentage of particles having a size of from 0.4 μm or more to less than 4.2 μm as the cumulative value of the volumetric basis: 53%, a percentage of particles having a size of less than 0.4 μm: 21%, a percentage of particles having a size of 4.2 μm or more: 26%), 10 parts of the synthetic amorphous silica C, 15 parts of the organic pigment A, 10 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper A, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Comparative Example 3

90 parts of calcium carbonate (product name: FMT-75 manufactured by Fimatec Ltd.), 10 parts of the synthetic amorphous silica C, 15 parts of the organic pigment A, 10 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper A, the coating material was applied using a blade coater at a coating weight of 12 g/m² per one surface. After coating, the base paper was dried to 5% moisture content, and was super calendered so that the white paper glossiness measured at a light incident angle of 75 degree according to JIS-Z8741 was 60% to provide an inkjet recording medium.

### Comparative Example 4

80 parts of the kaolin A, 20 parts of the synthetic amorphous silica E (product name: NIPGEL AY-600, manufactured by Tosoh Silica Corporation having a mean secondary particle diameter of 6.0 μm), 30 parts of the organic pigment A, 10 parts of SB latex (glass transition temperature of 15° C.) as the binder, 0.2 parts of sodium hydroxide, 0.2 parts of sodium polyacrylate as the dispersant, and dilution water were mixed to provide a coating material having 40% solid content. On both surfaces of the base paper A, the coating material was applied a blade coater at a coating weight of 12 g/m² per one surface. After coating, the base paper was dried to 5% moisture content, and was super calendered so that the white paper glossiness measured at a light incident angle of 75 degree according to JIS-Z8741 was 55% to provide an inkjet recording medium.

### <Evaluation>

1. White paper quality

### 1-1. White Paper Glossiness

White paper glossiness was measured at a light incident angle of 75 degree according to JIS-Z8741 using a gloss meter (True GLOSS GM-26PRO manufactured by Murakami Color Research Laboratory).

### 2. Inkjet Printing Quality

The ink jet printing was performed using the following commercially available pigment inkjet printer, and was evaluated as follows:

Printer for evaluation: PX-V630 manufactured by Seiko Epson Corporation

### 2-1. Drying Property (Ink Absorption Performance)

A black straight line having a width of 1.5 points was printed using the printer for evaluation (at a photo paper/high quality mode). After 10 minutes, the black straight line was rubbed with a finger, and was evaluated for drying property in accordance with the following criteria:

◯: When the black straight line was rubbed with a finger, the printed area almost was not bled. The ink absorption speed was high. The drying property level is excellent.
Δ: When the black straight line was rubbed with a finger, the printed area was somewhat bled. The ink absorption speed was slightly low. But, the drying property level is for practical use.
X: When the black straight line was rubbed with a finger, the printed area was bled. The ink absorption speed was low. The drying property level is not for practical use.

### 2-2. Rubbing Resistance of the Printed Area

Five black straight lines each having a width of 1.5 points were printed in rows using the printer for evaluation (at a photo paper/high quality mode). After 5 hours, the printed area was rubbed with a dry cotton-tipped stick, and was evaluated for rubbing resistance in accordance with the following criteria:

◯: When the black straight lines were rubbed with a cotton-tipped stick, the ink was not peeled, and the rubbing resistance level is excellent.
Δ: When the black straight lines were rubbed with a cotton-tipped stick, the ink was somewhat peeled, but the rubbing resistance level is for practical use.
X: When the black straight lines were rubbed with a cotton-tipped stick, the ink was peeled, and the rubbing resistance level is not for practical use.
2-3. Texture for Comparing with that of a Coating Paper for Offset Printing

A predetermined pattern (Color Test Chart No. 2 in accordance with JIS X6933) was inkjet printed on the inkjet recording medium with the printer. The same pattern was offset printed on a coating paper for offset printing (Aurora Coat manufactured by Nippon Paper Group Inc. having a basis weight of 104.7 g/m²). The texture such as the appearance and the touch of the ink jet printed area was compared with that of the offset printed area, and was evaluated as follows:

◯: The texture such as the appearance and the tough of the inkjet recording medium is similar to that of the coating paper for offset printing, so that the inkjet recording medium has the texture similar to that of the coating paper for offset printing.
X: The texture such as the appearance and the tough of the inkjet recording medium is different from that of the coating paper for offset printing, so that the inkjet recording medium has no texture similar to that of the coating paper for offset printing.
2-4. Curl after Printing

A black solid was printed over entire the A4 size inkjet recording medium using the printer for evaluation (at a photo paper/high quality mode). Immediately after the medium was ejected from the printer, the curl was evaluated as follows:

◯: The medium was negligibly curled, but has no problem.
Δ: The medium was slightly curled, but is for practical use.
X: The medium was significantly curled, and is not for practical use.

The results obtained are shown in Tables 1 and 2.

TABLE 1

| | | | Ink receiving layer | | | | | | | |
|---|---|---|---|---|---|---|---|---|---|---|
| | | | Kaolin | | | | | | | |
| | | | Percentage | Percentage | | | | | | |
| | | | of particles | of particles | | | | | | |
| | | | of 0.4 μm or | of less | | | | | | |
| | | | more to less | than 0.4 μm | Percentage of | | Silica | | | |
| | | | than 4.2 μm | size as the | particles of | Amount of | Amount of | | Amount of | |
| | | | size as the | cumulative | 4.2 μm or more | kaolin to | sillica to | | Binder to | |
| | | | cumulative | value | size as the | 100 wt parts | 100 wt parts | Mean | 100 wt parts | |
| | | | value | of | cumulative | of inorganic | of inorganic | secondary | of inorganic | White |
| | Base paper | | of the | the | value | pigment | pigment | particle | pigment | paper |
| | | Density | volumetric | volumetric | of the volumetric | (parts by | (parts by | size | (parts by | glossiness |
| | Type | (g/m³) | basis (%) | basis (%) | basis (%) | weight) | weight) | (μm) | weight) | (%) |
| Ex. 1 | A | 0.65 | 71 | 18 | 11 | 80 | 20 | 1.8 | 10 | 60 |
| Ex. 2 | A | 0.65 | 71 | 18 | 11 | 80 | 20 | 1.9 | 10 | 60 |
| Ex. 3 | A | 0.65 | 71 | 18 | 11 | 90 | 10 | 1.3 | 10 | 60 |
| Ex. 4 | A | 0.65 | 71 | 18 | 11 | 80 | 20 | 1.3 | 15 | 60 |
| Ex. 5 | A | 0.65 | 71 | 18 | 11 | 80 | 20 | 1.9 | 10 | 60 |
| Ex. 6 | B | 0.65 | 71 | 18 | 11 | 80 | 20 | 1.8 | 10 | 60 |
| Ex. 7 | B | 0.65 | 71 | 18 | 11 | 80 | 20 | 1.9 | 10 | 60 |
| Ex. 8 | B | 0.65 | 71 | 18 | 11 | 90 | 10 | 1.3 | 10 | 60 |
| Ex. 9 | B | 0.65 | 71 | 18 | 11 | 80 | 20 | 1.3 | 15 | 60 |
| Ex. 10 | B | 0.65 | 71 | 18 | 11 | 80 | 20 | 1.9 | 10 | 60 |
| Ex. 11 | C | 0.77 | 71 | 18 | 11 | 80 | 20 | 1.8 | 10 | 60 |
| Ex. 12 | B | 0.65 | 71 | 18 | 11 | 80 | 20 | 3.0 | 9 | 60 |
| Ex. 13 | B | 0.65 | 71 | 18 | 11 | 55 | 45 | 1.8 | 25 | 60 |
| Comp. Ex. 1 | A | 0.65 | 71 | 18 | 11 | 100 | 0 | — | 5 | 70 |
| Comp. Ex. 2 | A | 0.65 | 53 | 21 | 26 | 90 | 10 | 1.3 | 10 | 60 |
| Comp. Ex. 3 | A | 0.65 | — | — | — | 0 | 10 | 1.3 | 10 | 60 |
| Comp. Ex. 4 | A | 0.65 | 71 | 18 | 11 | 80 | 20 | 6.0 | 10 | 55 |

TABLE 2

| | Inkjet printing quality | | | |
|---|---|---|---|---|
| | | | Texture for | |
| | | rubbing | comparing with | |
| | | resistance | that of coating | Curl |
| | Drying | of printed | paper for | after |
| | property | area | offset printing | printing |
| Ex. 1 | ◯ | ◯ | ◯ | — |
| Ex. 2 | ◯ | ◯ | ◯ | — |
| Ex. 3 | Δ | Δ | ◯ | — |
| Ex. 4 | ◯ | ◯ | ◯ | — |
| Ex. 5 | ◯ | ◯ | ◯ | — |
| Ex. 6 | ◯ | ◯ | ◯ | ◯ |
| Ex. 7 | ◯ | ◯ | ◯ | ◯ |
| Ex. 8 | Δ | Δ | ◯ | ◯ |
| Ex. 9 | ◯ | ◯ | ◯ | ◯ |
| Ex. 10 | ◯ | ◯ | ◯ | ◯ |
| Ex. 11 | ◯ | ◯ | ◯ | Δ |
| Ex. 12 | ◯ | ◯ | ◯ | ◯ |
| Ex. 13 | ◯ | ◯ | ◯ | ◯ |
| Comp. Ex. 1 | X | X | ◯ | ◯ |
| Comp. Ex. 2 | X | Δ | ◯ | ◯ |
| Comp. Ex. 3 | X | Δ | ◯ | ◯ |
| Comp. Ex. 4 | ◯ | ◯ | X | ◯ |

The data in Tables 1 and 2 clearly indicated that, in each Example, the rubbing resistance of the image was excellent, the ink absorption performance was excellent, various performances were provided well-balanced, and the texture similar to that of the coating paper for offset printing was provided. In Examples 6 to 13, the curl after printing was evaluated, and the curl was favorably less produced. In Example 11 using the base paper C having a density exceeding 0.7 g/m³, the medium was more curled than the mediums in other Examples, but could be used practically. In Examples 3 and 8 where the percentage of the synthetic amorphous silica was lower than that of kaolin as compared with other Examples, the ink absorption performance and the rubbing resistance were somewhat low, but could be used practically.

In contrast, in Comparative Example 1 containing no synthetic amorphous silica at all, the ink absorption performance and the rubbing resistance in the printed area were poor. It would appear that, since the voids of the ink receiving layer were significantly decreased, thereby lowering the ink retention capacity in the ink receiving layer.

In Comparative Example 2 where the percentage of particles having a size of from 0.4 μm or more to less than 4.2 μm was less than 60% of the total as the cumulative value of the volumetric basis, and in Comparative Example 3 containing no kaolin at all, the ink absorption performance was poor. It would appear that the particle size distribution of the pigment was broad, so that the ink receiving layer was thickened, resulting in the lowered ink absorption performance.

In Comparative Example 4 where the mean secondary particle diameter of the synthetic amorphous silica exceeded 4 μm, the texture similar to that of the coating paper for offset printing could not be provided. It would appear that, since the particle size of the silica particles was great, the surface was very rough even though the calendering was conducted, and the glossiness was uneven.

What is claimed is:

1. An inkjet recording medium comprising an ink-receiving layer containing kaolin, synthetic amorphous silica and a binder formed on one surface or both surfaces of a base paper mainly containing a wood pulp, wherein the kaolin has a particle size distribution in which a percentage of particles having a size of from 0.4 μm or more to less than 4.2 μm which account for 60% or more of the total as the cumulative value of the volumetric basis by a laser diffraction particle size distribution measurement, and the synthetic amorphous silica has a mean secondary particle diameter of from 0.5 μm or more to 4 μm or less measured by a coulter counter method.

2. The inkjet recording medium according to claim 1, wherein the synthetic amorphous silica is gel type silica.

3. The inkjet recording medium according to claim 1 or 2, wherein the ink-receiving layer contains an organic pigment as a pigment.

4. The inkjet recording medium according to any one of claims 1-3, wherein a high-bulk paper is used as the base paper.
